(19) United States
(12) Patent Application Publication
(10) Pub. No.: US 2025/0342516 A1
(43) Pub. Date: Nov. 6, 2025

(54) MACHINE LEARNING-BASED ITEM RERANKING BASED ON USER QUERY AND CART CONTEXT

(71) Applicant: Walmart Apollo, LLC, Bentonville, AR (US)

(72) Inventors: Yang Yu, Cranbury, NJ (US); Varun Joshi, Jersey City, NJ (US); Semih Yagli, Jersey City, NJ (US); Jingbo Liu, Princeton, NJ (US); Cun Mu, New York, NY (US); Zheng Yan, Short Hills, NJ (US)

(73) Assignee: Walmart Apollo, LLC, Bentonville, AR (US)

(21) Appl. No.: 19/195,335

(22) Filed: Apr. 30, 2025

Related U.S. Application Data
(60) Provisional application No. 63/641,885, filed on May 2, 2024.

(51) Int. Cl. G06Q 30/0601; G06N 20/20; G06Q 10/087

(52) U.S. Cl. CPC G06Q 30/0633; G06N 20/20; G06Q 10/087; G06Q 30/0643

(57) ABSTRACT

A system including a processor and a non-transitory computer-readable media storing computing instructions that, when executed on the processor, cause the processor to perform operations comprising receiving user session information for a current session for a user; generating, using a ranking model, a first listing of items based on the user session information; generating, using a query model, a query intent measurement based on the user session information; generating, using a cart context model, a cart context measurement based on the user session information; generating a second listing of items based on the first listing of items, the query intent measurement, and the cart context measurement; and displaying the second listing of items in a graphical user interface to the user. Other embodiments are described.

### CROSS-REFERENCE TO RELATED APPLICATION

This application claims the benefit of U.S. Provisional Application No. 63/641,885, filed May 2, 2024, which is incorporated herein by reference in its entirety.

### TECHNICAL FIELD

This disclosure relates generally to machine learning-based item reranking based on user query and cart context.

### BACKGROUND

User queries and intents are spread across a wide range of spectrum. When ordering online, some users intend to pick up the order in a store, while other users prefer to use a delivery driver to pick up the order at the store and deliver the order to the home of the user. Meanwhile, other users intend for the order to be shipped (e.g., by mail) to the user.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for machine learning-based item reranking based on user query and cart context, according to an embodiment;

FIG. 4 illustrates a flow chart for a method, according to an embodiment;

FIG. 5 illustrates a system architecture, according to certain embodiments;

FIG. 6 illustrates a first graphical user interface that includes a first listing of items in a first display state; and

FIG. 7 illustrates a second graphical user interface that includes a second listing of items in a second display state.

### DETAILED DESCRIPTION

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

A number of embodiments can include a system. The system can include a processor and a non-transitory computer-readable medium storing computing instructions that, when executed on the processor, cause the processor to perform certain operations. The operations can include: receiving user session information for a current session for a user; generating, using a ranking model, a first listing of items based on the user session information; generating, using a query model, a query intent measurement based on the user session information; generating, using a cart context model, a cart context measurement based on the user session information; generating a second listing of items based on the first listing of items, the query intent measurement, and the cart context measurement; and displaying the second listing of items in a graphical user interface to the user.

Various embodiments include a computer-implemented method. The method can include: receiving user session information for a current session for a user; generating, using a ranking model, a first listing of items based on the user session information; generating, using a query model, a query intent measurement based on the user session information; generating, using a cart context model, a cart context measurement based on the user session information; generating a second listing of items based on the first listing of items, the query intent measurement, and the cart context measurement; and displaying the second listing of items in a graphical user interface to the user.

Additional embodiments include a non-transitory computer-readable medium storing computing instructions that, when executed on a processor, cause the processor to perform certain operations. The operations can include: receiving user session information for a current session for a user; generating, using a ranking model, a first listing of items based on the user session information; generating, using a query model, a query intent measurement based on the user session information; generating, using a cart context model, a cart context measurement based on the user session information; generating a second listing of items based on the first listing of items, the query intent measurement, and the cart context measurement; and displaying the second listing of items in a graphical user interface to the user.

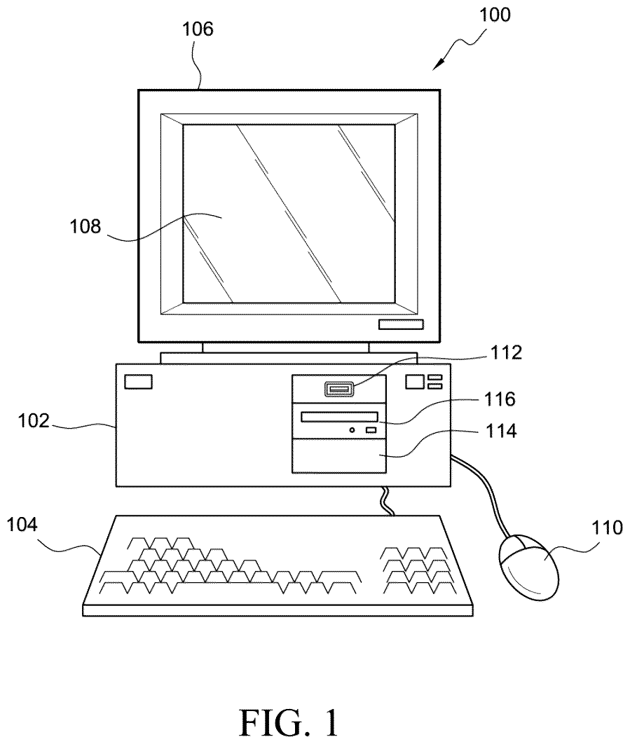

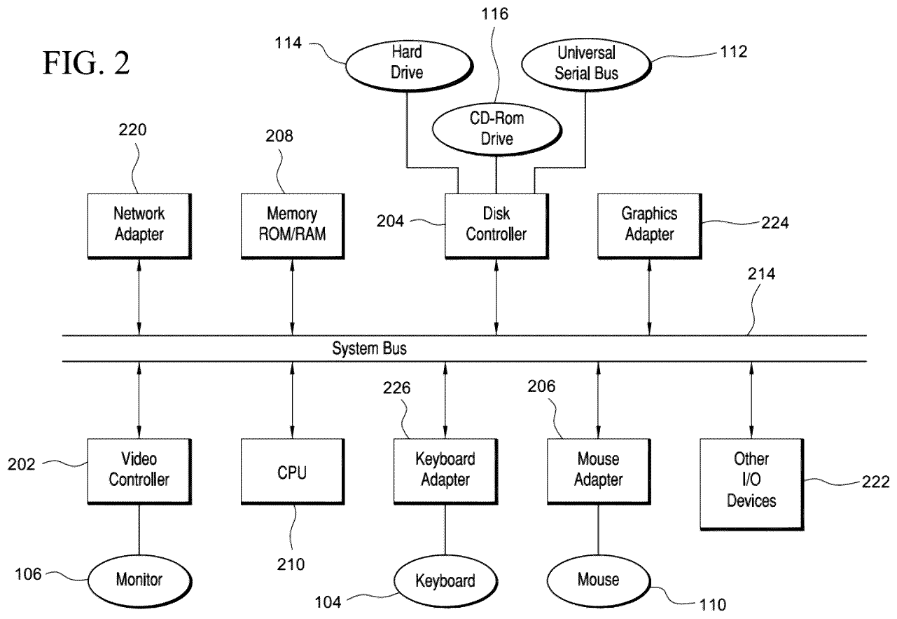

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a monitor 106, a keyboard 104, and/or a mouse 110, etc.) also can be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) non-volatile memory, such as, for example, read only memory (ROM) and/or (ii) volatile memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In these or other embodiments, memory storage unit 208 can comprise (i) non-transitory memory and/or (ii) transitory memory.

In many embodiments, all or a portion of memory storage unit 208 can be referred to as memory storage module(s) and/or memory storage device(s). In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Washington, United States of America, (ii) Mac®OS X by Apple Inc. of Cupertino, California, United States of America, (iii) UNIX®OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs. In many embodiments, an application specific integrated circuit (ASIC) can comprise one or more processors or microprocessors and/or memory blocks or memory storage.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile electronic device, such as a smartphone. In certain additional embodiments, computer system 100 may comprise an embedded system.

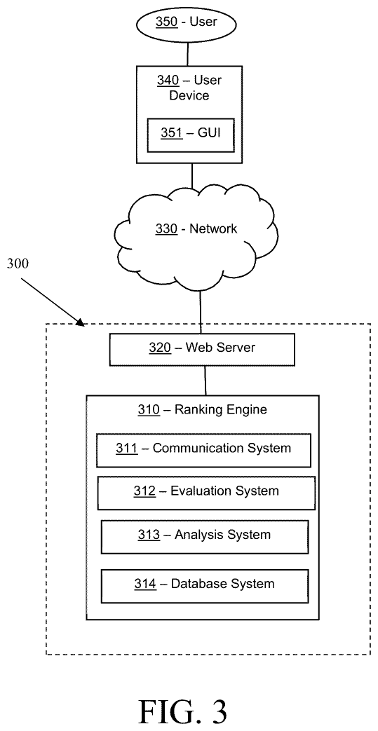

Turning ahead in the drawings, FIG. 3 illustrates a block diagram of a system 300 that can be employed for machine learning-based item reranking based on user query and cart context, according to an embodiment. System 300 is merely exemplary, and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include a ranking engine 310 and/or web server 320.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Ranking engine 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host ranking engine 310 and/or web server 320. Additional details regarding ranking engine 310 and/or web server 320 are described herein.

In some embodiments, web server 320 can be in data communication through a network 330 with one or more user devices, such as a user device 340, which also can be part of system 300 in various embodiments. User device 340 can be part of system 300 or external to system 300. Network 330 can be the Internet or another suitable network. In some embodiments, user device 340 can be used by users, such as a user 350. In many embodiments, web server 320 can host one or more websites and/or mobile application servers. For example, web server 320 can host a website, or provide a server that interfaces with an application (e.g., a mobile application), on user device 340, which can allow users (e.g., 350) to interact with ranking engine 310, in addition to other suitable activities. In a number of embodiments, web server 320 can interface with ranking engine 310 when a user (e.g., 350) is viewing infrastructure components in order to assist with the analysis of the infrastructure components corresponding to ranking analysis.

In some embodiments, an internal network that is not open to the public can be used for communications between ranking engine 310 and web server 320 within system 300. Accordingly, in some embodiments, ranking engine 310 (and/or the software used by such systems) can refer to a back end of system 300 operated by an operator and/or administrator of system 300, and web server 320 (and/or the software used by such systems) can refer to a front end of system 300, as is can be accessed and/or used by one or more users, such as user 350, using user device 340. In these or other embodiments, the operator and/or administrator of system 300 can manage system 300, the processor(s) of system 300, and/or the memory storage unit(s) of system 300 using the input device(s) and/or display device(s) of system 300.

In certain embodiments, the user devices (e.g., user device 340) can be desktop computers, laptop computers, mobile devices, and/or other endpoint devices used by one or more users (e.g., user 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, California, United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, New York, United States of America. In other specific examples, a head mountable wearable user computer device can comprise the Virtual Retinal Display™ product, or similar product by the University of Washington of Seattle, Washington, United States of America. Meanwhile, in further specific examples, a limb mountable wearable user computer device can comprise the iWatch™ product, or similar product by Apple Inc. of Cupertino, California, United States of America, the Galaxy Gear or similar product of Samsung Group of Samsung Town, Seoul, South Korea, the Moto 360 product or similar product of Motorola of Schaumburg, Illinois, United States of America, and/or the Zip™ product, One™ product, Flex™ product, Charge™ product, Surge™ product, or similar product by Fitbit Inc. of San Francisco, California, United States of America.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Washington, United States of America.

In many embodiments, ranking engine 310 and/or web server 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to ranking engine 310 and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of ranking engine 310 and/or web server 320. In a similar manner, the processors and/or the non-transitory computer-readable media can be local and/or remote to each other.

Meanwhile, in many embodiments, ranking engine 310 and/or web server 320 also can be configured to communicate with one or more databases, such as a database system 314. The one or more databases can include product catalog information, user engagement information, and/or machine learning training data, for example, among other data as described herein. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, ranking engine 310, web server 320, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, ranking engine 310 can include a communication system 311, an evaluation system 312, an analysis system 313, and/or database system 314. In many embodiments, the systems of ranking engine 310 can be modules of computing instructions (e.g., software modules) stored at non-transitory computer readable media that operate on one or more processors. In other embodiments, the systems of ranking engine 310 can be implemented in hardware. Ranking engine 310 and/or web server 320 each can be a computer system, such as computer system 100 (FIG. 1), as described above, and can be a single computer, a single server, or a cluster or collection of computers or servers, or a cloud of computers or servers. In another embodiment, a single computer system can host ranking engine 310 and/or web server 320. Additional details regarding ranking engine 310 and the components thereof are described herein.

In many embodiments, user device 340 can comprise a graphical user interface (GUI) 351. In the same or different embodiments, GUI 351 can be part of and/or displayed by user device 340, which also can be part of system 300. In some embodiments, GUI 351 can comprise text and/or graphics (image) based user interfaces. In the same or different embodiments, GUI 351 can comprise a heads up display (“HUD”). When GUI 351 comprises a HUD, GUI 351 can be projected onto a medium (e.g., glass, plastic, etc.), displayed in midair as a hologram, or displayed on a display (e.g., monitor 106 (FIG. 1)). In various embodiments, GUI 351 can be color, black and white, and/or greyscale. In many embodiments, GUI 351 can comprise an application running on a computer system, such as computer system 100 (FIG. 1), user device 340. In the same or different embodiments, GUI 351 can comprise a website accessed through network 330. In some embodiments, GUI 351 can comprise an eCommerce website. In these or other embodiments, GUI 351 can comprise an administrative (e.g., back end) GUI allowing an administrator to modify and/or change one or more settings in system 300. In the same or different embodiments, GUI 351 can be displayed as or on a virtual reality (VR) and/or augmented reality (AR) system or display. In some embodiments, an interaction with a GUI can comprise a click, a look, a selection, a grab, a view, a purchase, a bid, a swipe, a pinch, a reverse pinch, etc.

In some embodiments, web server 320 can be in data communication through network 330 (e.g., Internet) with user computers (e.g., 340). In certain embodiments, user devices 340 can be desktop computers, laptop computers, smart phones, tablet devices, and/or other endpoint devices. Web server 320 can host one or more websites. For example, web server 320 can host an eCommerce website that allows users to browse and/or search for products, to add products to an electronic shopping cart, and/or to purchase products, in addition to other suitable activities.

In many embodiments, ranking engine 310, and/or web server 320 can be configured to communicate with one or more user devices 340. In some embodiments, user devices 340 also can be referred to as customer computers. In some embodiments, ranking engine 310, and/or web server 320 can communicate or interface (e.g., interact) with one or more customer computers (such as user devices 340) through a network 330. Network 330 can be an intranet that is not open to the public. In further embodiments, network 330 can be a mesh network of individual systems. Accordingly, in many embodiments, ranking engine 310, and/or web server 320 (and/or the software used by such systems) can refer to a back end of system 300 operated by an operator and/or administrator of system 300, and user device 340 (and/or the software used by such systems) can refer to a front end of system 300 used by one or more users 350, respectively. In some embodiments, users 350 can also be referred to as customers, in which case, user device 340 can be referred to as customer computers. In these or other embodiments, the operator and/or administrator of system 300 can manage system 300, the processing module(s) of system 300, and/or the memory storage module(s) of system 300 using the input device(s) and/or display device(s) of system 300.

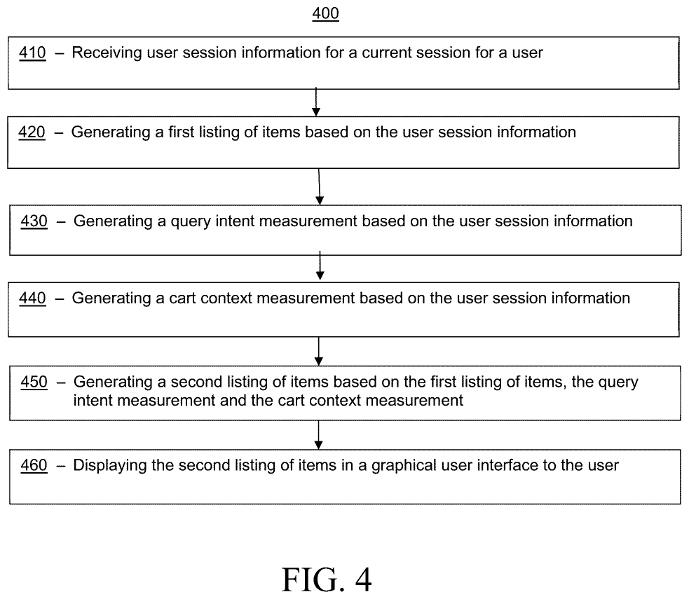

Turning ahead in the drawings, FIG. 4 illustrates a flow chart for a method 400, according to an embodiment. Method 400 is merely exemplary and is not limited to the embodiments presented herein. Method 400 can be employed in many different embodiments or examples not specifically depicted or described herein. In some embodiments, the activities of method 400 can be performed in the order presented. In other embodiments, the activities of method 400 can be performed in any suitable order. In still other embodiments, one or more of the activities of method 400 can be combined or skipped. In many embodiments, system 300 (FIG. 3) can be suitable to perform method 400 and/or one or more of the activities of method 400. In these or other embodiments, one or more of the activities of method 400 can be implemented as one or more computer instructions configured to run at one or more processing modules and configured to be stored at one or more non-transitory memory storage modules. Such non-transitory memory storage modules can be part of a computer system such as ranking engine 310, web server 320, and/or user device 340 (FIG. 3). The processing module(s) can be similar or identical to the processing module(s) described above with respect to computer system 100 (FIG. 1).

In many embodiments, method 400 can comprise an activity 410 of receiving user session information for a current session for a user. In some embodiments, the user session information includes a search query, a unique identifier (e.g., code, token, etc.), and one or more items in an online shopping cart corresponding to the unique identifier.

In some embodiments, the user session information can include the user's historical search queries during the current session and/or during a previous session, navigation patterns during the current session and/or during a previous session, items added to or removed from the online shopping cart during the current session and/or during a previous session, time spent on different pages during the current session and/or during a previous session, and any interactions with the graphical user interface during the current session and/or during a previous session.

In some embodiments, activity 410 can include generating attributes for the user session information. For example, the user session information can include a search query for “Samsung 55in tv”, and activity 410 can determine that “Samsung” corresponds to a brand, “55in” corresponds to a size (e.g., 55 inches), and “tv” corresponds to a product (e.g., a television). These attributes can be utilized in further processing to determine a listing of items. In this embodiment, the listing of items can include televisions from Samsung that are 55 inches.

Next, in many embodiments, method 400 can comprise an activity 420 of generating, using a ranking model, a first listing of items based on the user session information. In some embodiments, the first listing of items may include products that the user has shown an interest in during the current or previous sessions (through viewing a page for the items, putting the items in the online shopping cart, checking out with the items, etc.), items related to the user's search query, trending products based on other users' online activity, items with high conversion rates for other users, and/or products that complement items already in the user's online shopping cart. For example, if the user session information indicates that the user has been searching for running shoes, the first listing of items may include various models of running shoes, athletic wear that is commonly purchased with running shoes, and accessories such as socks or insoles. In some embodiments, the first listing of items may be recommended items based on the user's past purchase history, such as a specific brand of running shoes that the user has bought before.

In some embodiments, factors such as the user's previous searches, purchase history, items viewed but not purchased, and any preferences or wish lists the user may have created may also be considered. This enables identifying patterns and preferences that are specific to the user, which informs the generation of the first listing of items. In some embodiments, contextual information can be considered such as the time of day, seasonality, and current promotions or sales events to further tailor the first listing of items. For example, if the user is shopping during a holiday season, items that are commonly purchased during that time can be prioritized.

In some embodiments, the ranking model comprises a baseline ranking model and a gradient boosted decision tree (GBDT) model. The first listing of items is generated through a multi-layered approach that leverages both the baseline ranking model and the GBDT model.

In some embodiments, generating the first listing of items based on the user session information further comprises generating, using the baseline ranking model, a baseline listing of items based on the user session information. In some embodiments, the baseline listing of items includes one or more items ranked based on query context information. For example, the query context information can include the attributes that were determined in activity 410. In some embodiments, the baseline listing of items includes a threshold number of items (e.g., 100, 200, 500, etc.).

In some embodiments, generating the first listing of items based on the user session information further comprises processing, using the GBDT model, the baseline listing of items to generate a revised listing of the baseline listing of items. In some embodiments, the GBDT model utilizes an ensemble learning technique that builds the model in a stage-wise fashion. In some embodiments, the GBDT model utilizes both regression and classification tasks. For example, the GBDT model can operate by combining the predictions from multiple decision trees to generate a final output that is more accurate and robust than the individual predictions generated by the individual trees. In some embodiments, the GBDT model is utilized to refine the baseline listing of items generated by the baseline ranking model. The baseline ranking model may initially rank items based on query context information, which includes the relevance of items to the search query and other user-specific information such as past behavior and preferences. The GBDT model processes this baseline listing by sequentially adding decision trees, where each tree attempts to correct the errors of the previous ensemble of trees. In some embodiments, the GBDT model uses a loss function to measure the discrepancy between the actual user interactions (such as clicks, purchases, or cart additions) and the predictions made by the current ensemble. The GBDT model then builds a new tree that predicts the gradient of the loss function with respect to the predictions. This new tree is added to the ensemble, and the process is repeated for a specified number of iterations or until a satisfactory level of accuracy is achieved.

In generating the first listing of items, the GBDT model takes the baseline listing as input and applies its ensemble of decision trees to re-rank the items. The GBDT model considers various factors such as item popularity, user interaction data, temporal trends (caused by the season, an approaching holiday, news-worthy events, etc.), and inventory levels. By processing the baseline listing through the GBDT model, the ranking model can identify and prioritize items that are more likely to be of interest to the user, even if they were not initially ranked high by the baseline model.

In some embodiments, generating the first listing of items based on the user session information further comprises modifying the revised listing based on one or more ranking criteria to generate the first listing of items. In some embodiments, once the GBDT model has generated the revised listing of items, the ranking model may further modify this listing based on additional ranking criteria, such as the out-of-stock status and fulfillment status of each item. In some embodiments, the out-of-stock status takes into account the current inventory levels, preventing items that are not available for immediate sale from being prominently featured in the recommendations (or preventing such items from being featured at all in the recommendations). Similarly, the fulfillment status reflects the various options for obtaining the product, such as in-store pickup or home delivery, allowing the system to prioritize items that align with the user's preferred method of fulfillment. The first listing of items represents a dynamically adjusted set of recommendations tailored to the user's current session information and inferred intent.

In many embodiments, method 400 can comprise an activity 430 of generating, using a query model, a query intent measurement based on the user session information. In some embodiments, the query model is a Bidirectional Encoder Representations from Transformers (BERT) model. In some embodiments, the query model utilizes the BERT model, an attention mechanism that learns contextual relations between words (or sub-words) in a text. Unlike directional models, which read the text input sequentially (left-to-right or right-to-left), the BERT model reads the text in its entirety and thus gains a deeper understanding of context and word relationships. In one embodiment, the BERT model can be utilized within the system to generate a query intent measurement. By analyzing the user session information, which includes the search query, the BERT model can discern the user's intent behind the query. For example, if a user searches for “apple,” the BERT model can determine whether the user is looking for information on the fruit, the technology company, or perhaps a local orchard, based on the context provided by the user's session data. In another embodiment, the BERT model can understand the sentiment behind user reviews or comments, which can then be used to inform the ranking of items or to provide insights into product popularity and customer satisfaction.

In some embodiments, the BERT model is pre-trained on a large corpus of text and then fine-tuned for specific tasks. In some embodiments, the BERT model can be fine-tuned with e-commerce data, such as product descriptions, user queries, and transactional data, to better understand and predict e-commerce search queries and user intent.

In some embodiments, the query model employed by the system can also be a fastText model. The fastText model can understand the semantic meaning of words by taking into account subword information, which can be beneficial for processing user queries that contain misspellings, abbreviations, or compound words. In some embodiments, the query model is utilized for efficiency and speed, making it suitable for real-time applications where rapid query processing is needed.

Other models that could serve as alternative embodiments for the query model include traditional machine learning models like Support Vector Machines (SVM) or Random Forests, which, while less sophisticated than deep learning models, can still provide robust performance with the right feature engineering. Additionally, other deep learning approaches such as Convolutional Neural Networks (CNNs) or Recurrent Neural Networks (RNNs), including Long Short-Term Memory (LSTM) networks, could be utilized for their ability to capture sequential patterns in text data. Each of these models offers a different balance of complexity, interpretability, and computational requirements, allowing the system to be tailored to the specific constraints and goals of the deployment environment.

In some embodiments, activity 430 can include a technical process for enhancing the functionality of the query model through the generation of training data, which is a concrete application of computer technology. This process involves executing a series of computer-implemented steps: initially, the system receives query item pairs over a designated timeframe. These pairs are then subjected to a normalization algorithm, which is a technical solution for standardizing the data to ascertain a fulfillment status for each query, thereby ensuring the data's utility for machine learning applications. Subsequently, the system employs a computational process to filter out queries that fail to meet a predetermined order threshold, thereby refining the dataset for more effective machine learning training. The resulting high-quality training data is then algorithmically partitioned into two distinct datasets: one designated as the training sample and the other as the test sample. The training sample is utilized in a computer-implemented learning process, where the query model is trained to recognize patterns and relationships within the data-a technical improvement to the model's predictive capabilities. In some embodiments, the test sample is used in a validation process, executed by the system, to assess the trained model's performance and its technical ability to generalize to new, unseen data, thereby ensuring the model's practical applicability and robustness in a real-world environment.

In some embodiments, activity 430 can include a process for training the query model. This training involves using the previously labeled training sample to adjust the model's parameters so that the model can accurately predict or classify new data. The test sample is used to validate the model's predictions and to ensure that the model has not overfitted to the training data. By using both the training and test samples, the system can fine-tune the query model to improve the query model's accuracy and reliability in real-world applications, such as understanding user queries and enhancing the relevance of search results.

In many embodiments, method 400 can comprise an activity 440 of generating, using a cart context model, a cart context measurement based on the user session information. In some embodiments, the cart context model is an analytical tool designed to interpret and leverage the information pertaining to the items that a user has added to their online shopping cart during a session. The functionality of the cart context model is based on an ability to measure various dimensions of the user's current shopping context. By examining the items in the cart, the cart context model can infer the user's shopping goals, such as whether the user is planning a specific event, making routine purchases, or exploring new products. This context is then used to tailor the shopping experience to the user's specific situation. In some embodiments, the cart context model processes the user session information, which includes the items currently in the user's cart. The cart context model assesses factors such as product categories, quantities, price ranges, and any patterns that emerge from the combination of items. For instance, if a user has added ingredients commonly used in baking to their cart, the model might infer that the user is interested in baking-related products. In some embodiments, the system can prioritize items that complement or are frequently purchased with the items in the cart. For example, if the user's cart suggests the user is preparing for a barbecue, the model might recommend barbecue sauces or grilling utensils. In some embodiments, the cart context model enhances personalization by adjusting the recommendations based on real-time cart data. As users add or remove items from their cart, the model dynamically updates its context measurement, ensuring that the recommendations remain relevant and responsive to the user's evolving shopping session. In some embodiments, the cart context model can be integrated with other predictive models, such as the query intent model, to provide a holistic view of the user's intent.

In many embodiments, method 400 includes an activity 450 of generating a second listing of items based on the first listing of items, the query intent measurement, and the cart context measurement. In one embodiment, the second listing of items may be a curated subset of the first listing, selectively chosen based on additional relevance criteria. In another embodiment, the second listing of items may encompass all items from the first listing, but re-ordered to prioritize items with higher relevance based on the user's current context. In further embodiments, the generation of the second listing of items involves algorithmically re-ranking the first listing. This re-ranking adjusts the position of items within the list according to their calculated probability of matching a first fulfillment status, which is indicative of the user's immediate purchase intentions, such as desiring to buy in-store or to arrange for store pickup. In some embodiments, the query intent measurement may be interpreted to reflect a probability that an item aligns with a user's broader shopping goals, such as items intended for a specific event or items that complement previously purchased goods. In these scenarios, the first fulfillment status could also encompass user preferences for product features, brand loyalty, or time-sensitive promotions. In some embodiments, the cart context measurement is utilized to infer a second fulfillment status, which may indicate a user's preference for delivery options, such as standard or expedited shipping to a designated address. The second fulfillment status could also reflect user preferences for environmentally friendly packaging, gift-wrapping services, or bundled deals that are apparent from the cart contents. In other embodiments, the system may incorporate user behavior patterns, historical purchase data, and predictive analytics to further refine the second listing of items. For example, the system could identify cross-selling opportunities by recognizing items that are frequently bought together and promoting these combinations in the second listing. In some embodiments, the system may integrate user feedback from previous interactions to adjust the second listing. This feedback could include user ratings, reviews, or return history, which the system processes to enhance the accuracy of future recommendations. The second listing of items represents a technologically advanced approach to personalizing the online shopping experience, ensuring that users are presented with options that are not just relevant, but also aligned with their specific fulfillment preferences and shopping context.

In additional embodiments, the generation of the second listing of items is further modified by incorporating real-time contextual information, such as the geolocation of the user and/or different stores based on the geolocation of the user. In some embodiments, the system can dynamically adjust the item rankings to prioritize items available for store pickup at nearby locations. This real-time geolocation data, coupled with the time of the user's search, enables the system to determine the operational status of nearby stores-whether they are currently open or closed and if the items are available for immediate pickup. If an item is identified as a “store item” with a fulfillment status of store pickup and the user's search coincides with the store's business hours, the system can move that item to a higher position in the second listing of items. This real-time optimization ensures that the recommendations are not just personalized but also practically actionable, providing users with immediate and convenient purchase options that align with their location and timing constraints.

In many embodiments, method 400 can comprise an activity 460 of displaying the second listing of items in a GUI to the user. In some embodiments, the display of the second listing of items is not merely a static presentation but can be a dynamic interface that allows for real-time updates and user interaction. For example, in some embodiments, the GUI may feature interactive elements such as filters and sorting options that allow users to customize the view according to their preferences, such as by price, brand, or user ratings. The GUI may also provide visual indicators for items with special statuses, like those available for immediate store pickup, items on sale, or new arrivals, enhancing the user's ability to make informed decisions. In other embodiments, the GUI can include a map integration that visually represents the locations of nearby stores where the items are available for pickup. This integration can be interactive, allowing the user to select a store and view the availability of items in real-time, along with estimated pickup times and directions. Additionally, the GUI may be personalized for each user, displaying the second listing of items with personalized messages or alerts, such as reminding the user of previously viewed items or notifying them of items that are almost out of stock. The GUI can also suggest complementary items or accessories, enhancing the shopping experience and potentially increasing the average order value. In embodiments where the system is accessed through a mobile device, the GUI may be optimized for touch interactions, with gestures such as swiping to navigate through the second listing of items or tapping to add items to the cart. The mobile GUI may also leverage device capabilities, such as haptic feedback, to provide tactile responses when items are added to the cart or when special promotions are available. The GUI is also designed to be adaptive, capable of adjusting its layout and content presentation based on the device being used, whether it's a desktop computer, tablet, or smartphone.

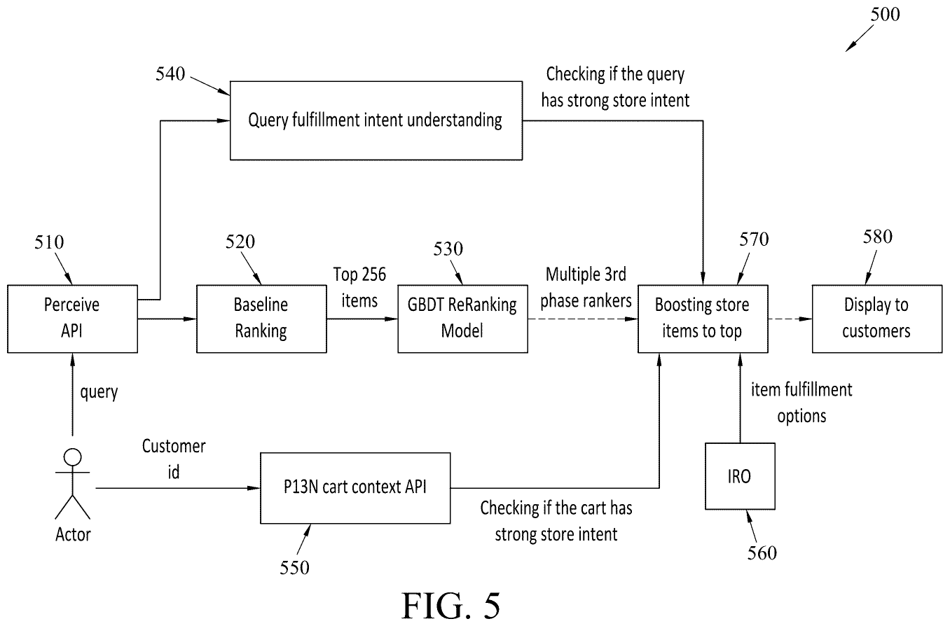

Turning ahead in the drawings, FIG. 5 illustrates a system architecture 500, according to certain embodiments. System architecture 500 represents a structured overview of the components and processes involved in the personalized item recommendation system as described in method 400 (FIG. 4).

Block 510 corresponds to activity 410 of receiving user session information for a current session for a user. This block represents the initial data intake mechanism of the system, where user-specific data such as search queries, user identifiers, and online cart contents are collected to inform subsequent processes.

Block 520 corresponds to activity 420 of generating, using a ranking model, a first listing of items based on the user session information. This block signifies the application of a baseline ranking model to the user session information to produce an initial set of item recommendations, which are then sorted based on relevance to the user's query context.

Block 530 represents a subsequent step in the ranking process and represents the processing of the baseline listing of items using the GBDT model to refine the recommendations further.

Block 540 corresponds to activity 430 of generating, using a query model, a query intent measurement based on the user session information. This block involves the use of a sophisticated query model, such as BERT, to interpret the user's search intent, which can influence the ranking and presentation of items.

Block 550 corresponds to activity 440 of generating, using a cart context model, a cart context measurement based on the user session information. This block reflects the system's capability to analyze the contents of a user's online cart to gauge the user's shopping context and preferences, which can also affect item recommendations.

Block 570 corresponds to activity 450 of generating a second listing of items based on the first listing of items, the query intent measurement, and the cart context measurement. This block represents the integration of the various measurements and models to produce a refined and personalized listing of items for the user.

Block 560 corresponds to modifying the second listing of items by incorporating real-time contextual information. This block indicates the system's ability to adjust the second listing based on dynamic factors such as the user's geolocation, store availability, and operational hours, ensuring that the recommendations are timely and actionable.

Block 580 corresponds to activity 460 of displaying the second listing of items in a GUI to the user. This block represents the final user-facing component of the system, where the personalized item recommendations are visually presented to the user through an interactive and adaptive GUI, facilitating user engagement and decision-making.

The system architecture 500 encapsulates the flow of data and the sequence of operations that lead to the generation and display of personalized item recommendations, with each block representing a distinct component or activity within the method 400 (FIG. 4).

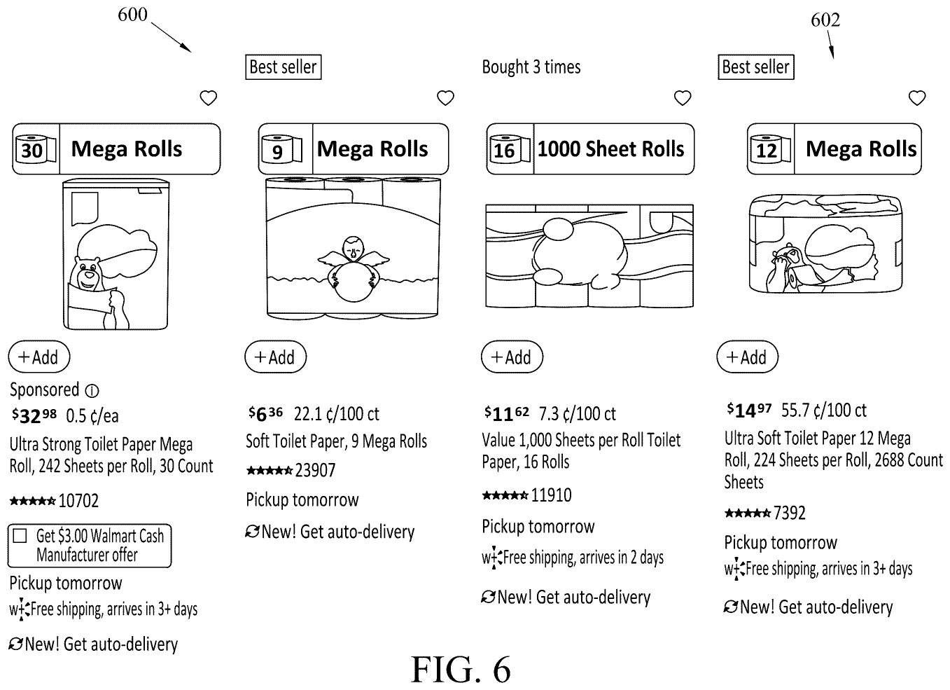

FIG. 6 illustrates a first GUI 600 that includes a first listing of items in a first display state. The first GUI 600 is designed to present items to the user in an organized and accessible manner. Within this interface, a first position 602 is prominently displayed, which includes a first item. This position is typically reserved for items that are deemed to be of high relevance or interest to the user, based on initial user session information or other criteria.

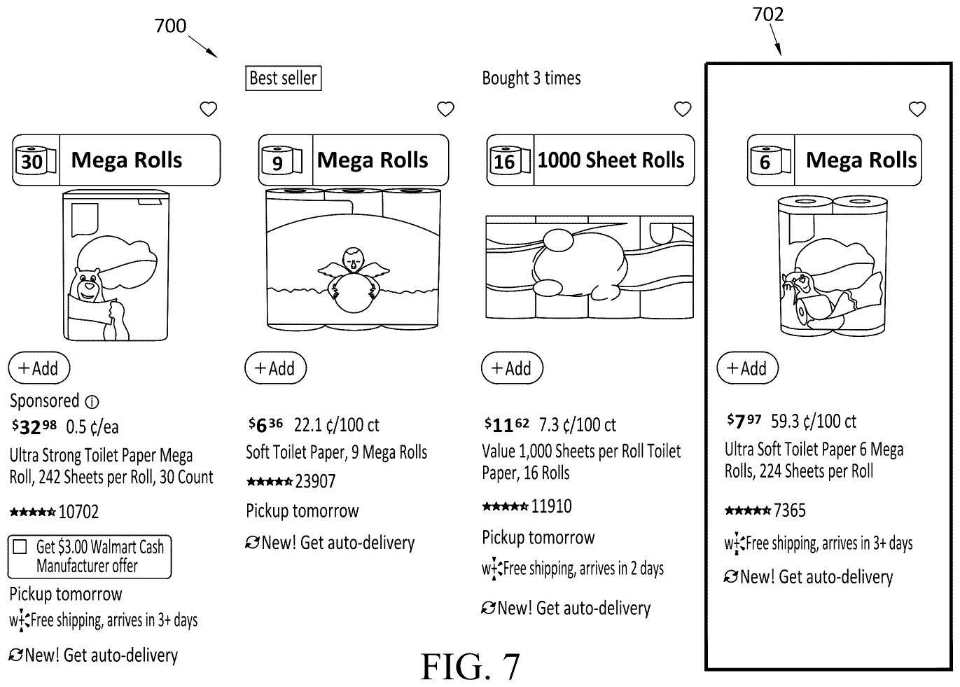

FIG. 7 illustrates a second GUI 700 that includes a second listing of items in a second display state. This second GUI 700 has undergone modifications as a result of the processes described in method 400 (FIG. 4). For example, the second GUI 700 features a second position 702, which corresponds to the first position 602 in the first GUI 600. However, the item displayed in the second position 702 has been updated based on the refined output of method 400 (FIG. 4) and a new item has been moved into this position. This change reflects the system's dynamic response to the user's session information, query intent, cart context, and other real-time factors, resulting in a personalized and optimized item presentation.

Returning to FIG. 3, in several embodiments, communication system 311 can at least partially perform activity 410 (FIG. 4) and/or activity 460 (FIG. 4).

In several embodiments, evaluation system 312 can at least partially perform activity 420 (FIG. 4).

In a number of embodiments, analysis system 313 can at least partially perform activity 430 (FIG. 4), activity 440 (FIG. 4), and/or activity 450 (FIG. 4).

In a number of embodiments, web server 320 can at least partially perform method 400.

Embodiments disclosed herein can provide technical improvements that address specific challenges in the field of machine learning models and ranking problems. These improvements are rooted in the advanced computational processes that enable the system to dynamically generate personalized item listings based on a complex interplay of user session information, query intent, and cart context. The use of sophisticated machine learning models, such as GBDT and BERT, represents a concrete application of technology that goes beyond mere automation of conventional activities. These models are intricately designed to interpret nuanced user data and adapt recommendations in real-time, which is a technical solution to the technical problem of providing relevant, context-aware content to users in an online environment. The system's architecture, which integrates these models to modify item listings and display them through a graphical user interface, reflects an inventive step that provides a specific, practical application of computer technology.

Although machine learning-based item reranking based on user query and cart context has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-7 may be modified, and that the foregoing discussion of certain of these embodiments does not necessarily represent a complete description of all possible embodiments. For example, one or more of the procedures, processes, or activities of FIG. 4 may include different procedures, processes, and/or activities and be performed by many different modules, in many different orders.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising a processor and a non-transitory computer-readable medium storing computing instructions that, when executed on the processor, cause the processor to perform operations comprising:
receiving user session information for a current session for a user;
generating, using a ranking model, a first listing of items based on the user session information;
generating, using a query model, a query intent measurement based on the user session information;
generating, using a cart context model, a cart context measurement based on the user session information;
generating a second listing of items based on the first listing of items, the query intent measurement, and the cart context measurement; and
displaying the second listing of items in a graphical user interface to the user.

2. The system of claim 1, wherein the user session information comprises a search query, a unique identifier, and one or more items in an online cart corresponding to the unique identifier.

3. The system of claim 1, wherein the ranking model comprises a baseline ranking model and a gradient boosted decision tree (GBDT) model.

4. The system of claim 3, wherein generating the first listing of items based on the user session information further comprises:
generating, using the baseline ranking model, a baseline listing of items based on the user session information, the baseline listing of items including one or more items ranked based on query context information;
processing, using the GBDT model, the baseline listing of items to generate a revised listing of the baseline listing of items; and
modifying the revised listing based on one or more ranking criteria to generate the first listing of items.

5. The system of claim 4, wherein the one or more ranking criteria are based on a respective out-of-stock status and a respective fulfillment status for each item in the revised listing.

6. The system of claim 1, wherein the query model is a Bidirectional Encoder Representations from Transformers (BERT) model.

7. The system of claim 1, wherein the operations further comprise generating training data by:
receiving query item pairs for a period of time;
normalizing the query item pairs to determine a fulfilment status for each query of the query item pairs;
removing each query that does not satisfy an order threshold to generate the training data;
labeling a first portion of the training data as a training sample; and
labeling a second portion of the training data as a test sample.

8. The system of claim 7, wherein the operations further comprise training the query model based on the training sample and the test sample.

9. The system of claim 1, wherein:
the query intent measurement corresponds to a probability of an item having a first fulfillment status; and
the cart context measurement corresponds to a probability of an item having a second fulfillment status.

10. The system of claim 9, wherein generating the second listing of items based on the first listing of items, the query intent measurement, and the cart context measurement further comprises modifying the first listing of items to move items of the first listing of items having a probability of an item having respective first fulfillment statuses to a higher position.

11. A computer-implemented method comprising:
receiving user session information for a current session for a user;
generating, using a ranking model, a first listing of items based on the user session information;
generating, using a query model, a query intent measurement based on the user session information;
generating, using a cart context model, a cart context measurement based on the user session information;
generating a second listing of items based on the first listing of items, the query intent measurement, and the cart context measurement; and
displaying the second listing of items in a graphical user interface to the user.

12. The computer-implemented method of claim 11, wherein the user session information comprises a search query, a unique identifier, and one or more items in an online cart corresponding to the unique identifier.

13. The computer-implemented method of claim 11, wherein the ranking model comprises a baseline ranking model and a gradient boosted decision tree (GBDT) model.

14. The computer-implemented method of claim 13, wherein generating the first listing of items based on the user session information further comprises:
generating, using the baseline ranking model, a baseline listing of items based on the user session information, the baseline listing of items including one or more items ranked based on query context information;
processing, using the GBDT model, the baseline listing of items to generate a revised listing of the baseline listing of items; and
modifying the revised listing based on one or more ranking criteria to generate the first listing of items.

15. The computer-implemented method of claim 14, wherein the one or more ranking criteria are based on a respective out-of-stock status and a respective fulfillment status for each item in the revised listing.

16. The computer-implemented method of claim 11, wherein the query model is a Bidirectional Encoder Representations from Transformers (BERT) model.

17. The computer-implemented method of claim 11, further comprising generating training data by:
receiving query item pairs for a period of time;
normalizing the query item pairs to determine a fulfilment status for each query of the query item pairs;
removing each query that does not satisfy an order threshold to generate the training data;
labeling a first portion of the training data as a training sample; and
labeling a second portion of the training data as a test sample.

18. The computer-implemented method of claim 17, further comprising training the query model based on the training sample and the test sample.

19. A non-transitory computer-readable medium storing computing instructions that, when executed on a processor, cause the processor to perform operations comprising:
receiving user session information for a current session for a user;
generating, using a ranking model, a first listing of items based on the user session information;
generating, using a query model, a query intent measurement based on the user session information;
generating, using a cart context model, a cart context measurement based on the user session information;
generating a second listing of items based on the first listing of items, the query intent measurement, and the cart context measurement; and
displaying the second listing of items in a graphical user interface to the user.

20. The non-transitory computer-readable medium of claim 19, wherein the user session information comprises a search query, a unique identifier, and one or more items in an online cart corresponding to the unique identifier.
